(19) United States
(12) Patent Application Publication
(10) Pub. No.: US 2004/0153418 A1
(43) Pub. Date: Aug. 5, 2004

(54) System and method for providing access to data from proprietary tools

(76) Inventor: Gerald Alfred Hanweck, New York, NY (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/358,921

(22) Filed: Feb. 5, 2003

(51) Int. Cl. G06F 17/60

(52) U.S. Cl. 705/67

(57) ABSTRACT

In certain aspects, the invention features a system and method for providing selected customers of a financial institution with access to secure data. A system embodiment of the present invention may include a computer-implemented market analysis tool adapted to compute, based on a market condition, financial data derived from a publicly available data source for a financial instrument, wherein the market analysis tool is proprietary and accessible only by authorized personnel within the financial institution. In accordance with such an aspect, the system may further include a first computing device configured to: receive, from at least one of the selected customers, a request for the financial institution to perform a predefined function, wherein the selected customer includes a user other than the authorized personnel, wherein the predefined function uses the derived financial data to create a result, and wherein the request is generated at least in part by including an identifier corresponding to the predefined function in a spreadsheet program running or otherwise accessible on a second computing device; and provide the result of the predefined function to the second computing device.

### BACKGROUND

I. Field of the Invention

The present invention relates to a system and method for exchanging information between computing devices, and more particularly, to systems and methods for providing access to data generated by proprietary tools.

II. Description of the Related Art

An equity derivative may be an instrument that derives its value from an equity security or equity index. Common equity derivative products may include equity futures, swaps, options, equity-linked notes, convertible bonds and warrants. Different organizations and practitioners (including financial institutions such as commercial banks and investment banks) have generated tools for performing certain functions, including (1) pricing equity derivatives and other instruments, and (2) determining the amount of risk associated with each such instrument. Tools used to price instruments and to determine their risk may be referred to as analytics, and may include procedures, models, and techniques used to perform an analysis of a situation, event or transaction. Different organizations or practitioners may develop or use different analytics, some or all of which may be proprietary to the organization or practitioner.

In certain instances, customers of a financial institution may be interested in obtaining certain information (e.g., pricing and risk information) about a particular instrument, a group of instruments, or other financial matters. However, the financial institution may not be in a position to allow such a customer (who is outside the group of personnel authorized to have access to proprietary tools such as analytics) to directly access proprietary tools such as analytics. Certain conventional systems and methods lack the ability to allow certain types of users to have access to certain types of data while also preventing such users from directly accessing proprietary tools used to generate the data.

An application service provider (ASP) is an entity or organization that may manage and distribute software-based services to customers (e.g., companies with online banking capabilities) from a central data server across a wide area network. Certain ASPs may be able to provide a company with a software service that enables customers of the company to use certain tools or databases provided by the company to obtain certain data. For example, certain ASPs may enable a customer of a bank to access derivatives analytics libraries. However, such a conventional system and method provides only a limited amount of information for each query, such that retrieval of a large amount of information based on a large number of queries may be a time consuming process.

Certain online trading and brokerage services allow a user to establish a trading account, and to access the balance and activity in the account by entering a user name and password. Upon verification of the user name and password, the online trading and brokerage service allows its customer to place a order for a trade, for example to sell a particular number of shares of a particular stock at the market price or to place an options order. Once the stock trade or options order has been executed by the clearing company with which the online service works, the service may send the customer a notice of the details of the trade, such as when it took place and the selling price. Certain online trading and brokerage services also allow a customer to receive options pricing information. For example, E*TRADE Financial will provide a customer with options chains for a particular stock based on values input by the customer, such as the stock price on a particular date, an investment amount, the volatility of the underlying stock, and the treasury bill rate. However, this conventional system and method may not allow data to be transferred easily into spreadsheet application for further manipulation.

### SUMMARY OF THE INVENTION

In one aspect, the invention features a system for use in providing selected customers of a financial institution with access to secure data, the system including a computer-implemented market analysis tool adapted to compute, based on a market condition, financial data derived from a publicly available data source for a financial instrument, wherein the market analysis tool is proprietary and accessible only by authorized personnel within the financial institution. In accordance with such an aspect, the system further includes a first computing device configured to: receive, from at least one of the selected customers, a request for the financial institution to perform a predefined function, wherein the selected customer includes a user other than the authorized personnel, wherein the predefined function uses the derived financial data to create a result, and wherein the request is generated at least in part by including an identifier corresponding to the predefined function in a spreadsheet program running or otherwise accessible on a second computing device; and provide the result of the predefined function to the second computing device.

In another aspect, the invention features a computer-implemented method for providing selected customers of a financial institution with access to secure data, the method including the step of computing financial data derived from a publicly available data source using a computer-implemented market analysis tool that is proprietary and accessible only by authorized personnel within the financial institution, the step of receiving, from at least one of the selected customers, a request for the financial institution to perform a predefined function, wherein the selected customer includes a user other than the authorized personnel, wherein the predefined function uses the derived financial data to create a result, and wherein the request is generated at least in part by including an identifier corresponding to the predefined function in a spreadsheet program running or otherwise accessible on a remote computing device accessible by the selected customer. According to such an aspect, the method further includes the step of performing the predefined function and providing the result of the predefined function to the remote computing device.

In yet another aspect, the invention features a computer-implemented method including the step of calculating a price for a derivative financial instrument, the calculating step including accessing a proprietary information source to produce a result, the step of receiving a request from a client computer, wherein the request includes a calling statement corresponding to an approved operation, and the client computer includes a codec module and a spreadsheet application, and the step of transmitting to the client computer an unformatted data stream including the result.

### BRIEF DESCRIPTION OF THE DRAWINGS

Features and other aspects of the invention are explained in the following description taken in conjunction with the accompanying drawings, wherein:

FIG. 1 illustrates certain aspects of a financial institution including an access server 300 according to one embodiment of the present invention;

FIG. 2 illustrates certain components of one embodiment of a client computer 100 as shown in FIG. 1;

FIG. 3 illustrates certain components of one embodiment of an access server 300 as shown in FIG. 1; and

FIGS. 4a and 4b illustrate one embodiment of a method of providing selected users of a financial institution with access to data.

It is to be understood that the drawings are exemplary, and are not limiting.

### DETAILED DESCRIPTION OF PREFERRED EMBODIMENTS

Various embodiments of the present invention will now be described in greater detail with reference to the drawings.

I. System Embodiments of the Invention

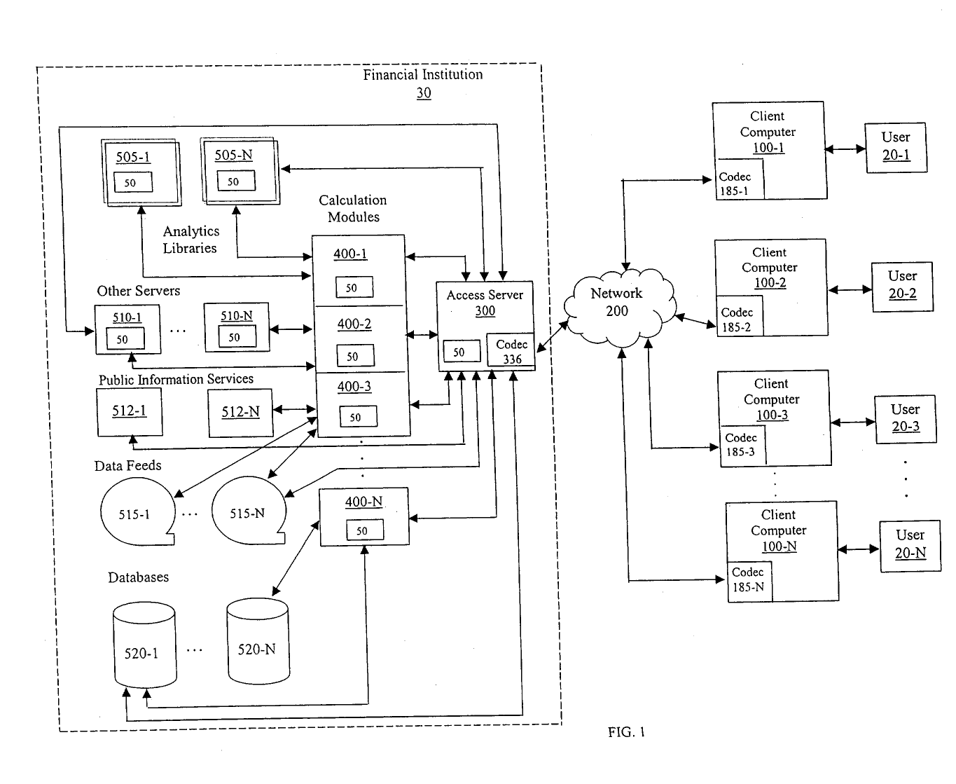

FIG. 1 illustrates components of one embodiment of a system according to the present invention. In particular, FIG. 1 depicts a number of client computers 100-1 to 100-N in communication, via a network 200, with an access server 300 of a financial institution 30 in turn in communication with a number of calculation modules 400-1 to 400-N and information sources 505-1 to 505-N, 510-1 to 510-N, 512-1 to 512-N, 515-1 to 515-N and 520-1 to 520-N.

One capability of this embodiment of the system 10 may be to provide certain customers or users 20-1 to 20-N of the financial institution 30 (e.g., a commercial bank or an investment bank) with access to data 40 (e.g., pricing data and/or risk information for equity derivatives) generated using one or more proprietary tools 50-1 to 50-N of the financial institution 30. In accordance with such an embodiment, the proprietary tools 50-1 to 50-N are not made accessible to personnel outside of the financial institution 30.

A. Client Computer 100

The client computer 100 may provide the financial institution 30 with a request 1000 for data 40 by, e.g., providing the name 80 and attributes 85-1 to 85-N of a predefined function 70 in a cell of a spreadsheet provided by the spreadsheet application 180.

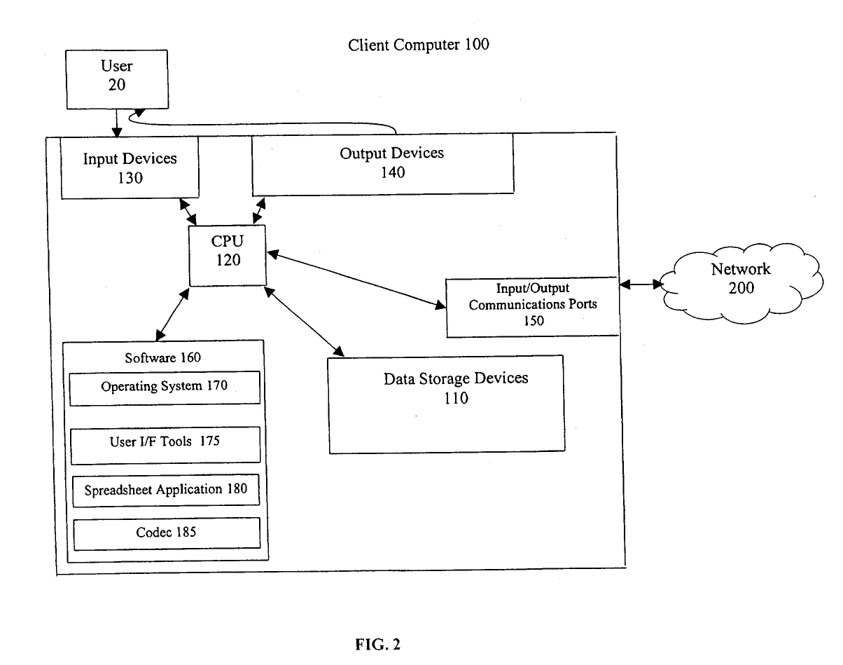

In the embodiment depicted in FIGS. 1 and 2, each client computer 100 may generally include one or more data storage devices 110, a central processing unit (CPU) 120, one or more input devices 130, one or more output devices 140, input/output (I/O) communications ports 150, and other hardware components (not shown) which facilitate performance of the functions of the client computer 100 and as described herein. In one embodiment, the hardware devices of a client computer 100 may be in communication with one another by a shared data bus and/or by dedicated connections (not shown). In addition, a number of software components 160 may run on each client computer 100.

The data storage devices 110 of one embodiment may include one or more hard disk drives. However, it is to be understood that data storage devices 110 such as RAM, ROM, CD-ROM, DVD-ROM, solid state drive, floppy disk-drive or combinations thereof may also be included in the embodiment shown in FIGS. 1 and 2, or in certain other appropriate embodiments. One embodiment of a client computer 100-1 may include input device(s) 130 (e.g., keyboard, pointing/selecting device such as a mouse or track ball, floppy disk-drive, scanner and/or touch screen interface) that may enable a user 20 to provide information and instructions to, and receive results from, the client computer 100 and/or access server 300. An embodiment of a client computer 100-1 may also include output devices 140 (e.g., printer, display device, floppy disk-drive and/or computer monitor) that may enable a user 20 to receive, for further manipulation and/or storage, information generated using the client computer 100 and/or the access server 300. The I/O communications ports 150 of a client computer 100 of one embodiment may be serial and parallel, and may be configured to include multiple communications channels for simultaneous connections. The software components 160 may include an operating system 170 (e.g., Linux, Unix, Microsoft Windows NT), one or more user interface tools 175, one or more spreadsheet applications 180 and an encoder/decoder module (“client codec module”) 185. One example spreadsheet application 180 may be MicroSoft Excel.

In one embodiment, the client codec module 185 may be a software program running on the client computer 100, and may interpret the unformatted data for use in a standard spreadsheet application 180 (e.g., MicroSoft Excel) also running on or otherwise accessible to the client computer 100. In addition, the client codec module 185 may translate a request 1000 that includes, e.g., two-dimensional data from the spreadsheet application 180 of the client computer 100 into a message format compatible with a server codec module 336 on the access server 300. Such a message format may be, for example, Extensible Mark-up Language (XML) rather than Transmission Control Protocol/Internet Protocol (TCP/IP), the latter of which may in certain circumstances not pass through certain firewalls. In this way, relationships between objects on the client computer 100 may be made available to the access server 300.

The client codec module 185 may be provided to the client computer 100 by the financial institution 30 by, for example, download over the network 200. In such an embodiment, the client codec module 185 may provide an interface between the spreadsheet application 180 and the access server 300, and may use a transparent communication protocol (e.g., simple object access protocol (SOAP), XML/HTTP or its variants). In one embodiment, a single protocol may be used for various programming languages (e.g., Java and C/C++), and a single client codec module 185 may be used for and compatible with several programming languages as well. This capability may be enabled by, for example, consistently representing two dimensional data by using objects (such as, e.g., Java objects) in a fixed format.

The client codec module 185 may include an add-in 186 to a spreadsheet application 180 and a library 187 (e.g., dynamic link library) of executable functions or data. The add-in 186 may include a control panel to enable a user 20 to enter or change configuration parameters such as, e.g., server name, port number, login information and caching information. In one embodiment, a request 1000 from the spreadsheet application 180 may invoke the library 187. Such a library 187 may parse parameters of the request 1000 and put such parameters into a single object array, and then call the server codec module 336 (e.g., WebServices) via a protocol such as SOAP.

B. Network 200

In the embodiment depicted in FIG. 1, the network 200 may be an internet. Although the network 200 of the embodiment shown in FIG. 1 may be an internet, in alternative embodiments, connections between client computers 100-1 to 100-N and the access server 300 may be of different types, including a connection over a telephone line, a direct connection, a local area network (LAN), a wide area network (WAN), an intranet or other network or combination of the aforementioned connections that is capable of communicating data between hardware and/or software devices. More than one client computer 100-1 to 100-N at a time may communicate with the access server 300 over the network 200.

In one embodiment, communication over the network 200 between a particular client computer 100 and the access server 300 may be accomplished using a communications protocol such as XML/HTTP, SOAP, XMLRPC, TCP/IP, file transfer protocol (FTP), or other suitable protocol or combination of protocols.

Using the network 200, a client computer 100 may request information from the access server 300 by sending a request 1000 particular communication protocol (e.g., SOAP). When the client computer 100 contacts the access server 300, the client computer 100 asks the access server 300 for information (e.g., in the form of a stream of unformatted data) by building a message with a compatible language and sending it. After processing the request, the access server 300 may send the requested information to the client computer 100 using the particular communication protocol (e.g., SOAP). Software 160 (e.g., a client codec module 185 and/or a spreadsheet application 180) running on the client computer 100 may then interpret or “decode” the information sent by the access server 300 and provide it to the user 20 (e.g., display it on an output device 140 such as a computer monitor using a spreadsheet application 180). In one embodiment, the access server 300 may communicate with a client computer 100 without the need for a secure protocol (e.g., secure socket layer (SSL)).

C. Access Server 300

In one embodiment, the access server 300 may be a web-based server that handles requests for data based on analytics, historical data, real-time data, combinations of these, or other information. The server may dispatch requests 1000-1 to 1000-N from a user 20 to an appropriate calculation module(s) 400-1 to 400-N. A calculation module 400 of one embodiment may include hardware and software configured to perform one or more predefined functions 70-1 to 70-N. For example, the calculation modules 400-1 to 400-N may perform the data access and analytical computations, and return results 1050-1 to 1050-N to the client computer 100.

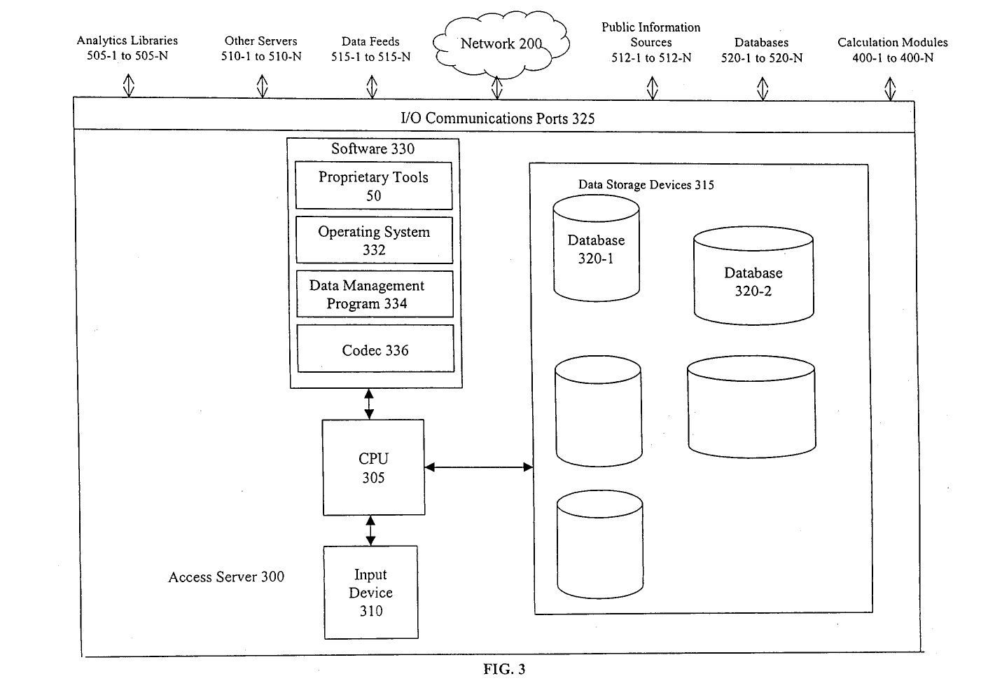

According to one embodiment, the access server 300 shown in FIGS. 1 and 3 may operate as, among other things, a gateway to and/or host of proprietary tools 50-1 to 50-N (e.g., analytics) of the financial institution 30. In this way, the access server 300 may enable a number of users 20-1 to 20-N to access derived financial data from a financial institution 30, using a client computer 100, without accessing the proprietary tools 50-1 to 50-N that are used to generate or obtain the data 40. Such an access server system 10 may also allow a user 20, using a spreadsheet application 180, to access, view and/or manipulate the derived financial data 40 on its client computer 100. In one embodiment, all communications between a client computer 100 and the access server 300 are secure and involve an authentication process before access to the access server 300 is granted.

In one embodiment, the access server 300 may be located at and/or maintained by the financial institution 30. Such an access server 300 may be able to perform or otherwise facilitate look-up functions 75 (e.g., get market data such as a composition of indexes (where the base data may be available publicly, but hard to consolidate)) as well as calculation functions 78 (e.g., calculate a price for an equity derivative). Using the proprietary tools 50-1 to 50-N (which may reside in a number of places within the financial institution 30), the financial institution 30 may generate derived data 40 from open market and other data to enable the user 20 to do further analysis or modeling with the derived data. Data provided by the access server 300 may include (as non-limiting examples of derived data): (1) pricing data; (2) financial data (created by the financial institution's models being applied to publicly available data); and (3) market information (e.g., composition of indexes).

FIG. 3 is a block diagram showing certain components of an access server 300 according to one embodiment of the present invention. As shown in FIG. 3, one embodiment of an access server 300 generally includes a central processing unit (CPU) 305 that is in communication with a number of components by a shared data bus or by dedicated connections-these components include one or more input devices 310 (e.g., a CD-ROM drive and/or tape drive) which enable information and instructions to be input for storage in the access server 300, one or more data storage devices 315, having one or more databases 320 defined therein, input/output (I/O) communications ports 325, and software 330. Each I/O communications port 325 has multiple communications channels for simultaneous connections with multiple client computers 100-1 to 100-N and multiple calculation modules 400-1 to 400-N. The software 330 may include certain proprietary tools 50, an operating system 332, database management programs 334 to store information and perform the operations or transactions described herein, and an encoder/decoder module (“server codec module”) 336. The access server 300 of one embodiment may access one or more calculation modules 400-1 to 400-N and/or other sources (e.g., analytics libraries 505-1 to 505-N, other servers 510-1 to 510-N, public information sources 512-1 to 512-N, data feeds 515-1 to 515-N and/or databases 520-1 to 520-N). The access server 300 may also access data storage devices 315 which may contain a number of databases 320-1 to 320-N. Although the embodiment shown in FIG. 3 depicts the access server 300 as a single server, a plurality of additional servers (not shown) may also be included as part of the access server 300.

In one embodiment, the access server 300 (via the server codec module 336) provides the client computer 100 with requested information in the form of an unformatted data stream 90. This unformatted data stream 90 may be useless to the client computer 100 without the corresponding client codec module 185 on the client computer 100. In such an embodiment, the financial institution 30 may provide authorized users 20 with a client codec module 185 which, in one embodiment, need not change even if the group of functions 70-1 to 70-N made available to a user 20 changes, increases in number, or decreases in number. Also in accordance with one embodiment, the client codec module 185 and server codec module 336 combine to perform data presentation operations (e.g., wrapping and unwrapping data used in the spreadsheet application 180) such that only core data (e.g., two-dimensional data) is communicated between a client computer 100 and access server 300. The server codec module 336 may also parse and validate parameters sent from the client codec module 185 prior to dispatch of the request 1000 to, e.g., an appropriate calculation module 400.

The access server 300 shown in FIG. 3 may perform the following functions: (1) receiving and storing requests 1000-1 to 1000-N from the client computers 100-1 to 100-N; (2) exchanging information with calculation modules 400-1 to 400-N such that requests 1000-1 to 1000-N are fulfilled (including invoking proprietary tools 50-1 to 50-N and appropriate calculation modules 400-1 to 400-N); (3) assembling results 1050-1 to 1050-N generated by the proprietary tools 50-1 to 50-N and calculation modules 400-1 to 400-N; (4) encoding the results 1050-1 to 1050-N; (5) fulfilling requests 1000-1 to 1000-N by directly invoking proprietary tools 50 of the access server 300; and (6) returning the results 1050-1 to 1050-N for viewing and manipulation by a user 20 using a spreadsheet application 180.

In one embodiment, the access server 300 (via the server codec module 336) allows a user 20, via a client computer 100, to view and manipulate an unformatted stream 90 of data 40 directly using a spreadsheet application 180. The proprietary tools 50-1 to 50-N used to create and/or retrieve the derived data 40, however, are not exposed to the user 20 or the client computer 100. Rather, the proprietary tools 50-1 to 50-N may remain protected and only accessible to authorized personnel within the financial institution 30. In this way, approved users 20-1 to 20-N may access the derived data 40 created by the proprietary tools 50-1 to 50-N, but are not provided direct access to the proprietary tools 50-1 to 50-N themselves.

According to one embodiment, once a financial institution 30 has provided a user 20 with an authorization password, a name 80 and attributes 85-1 to 85-N of a function 70, and a client codec module 185, the user 20 may access data by requesting performance of the function 70. The access server 300 may itself perform the requested function 70, or may cause the function 70 to be performed by another device or system such as, e.g., a calculation module 400. In this way, the financial institution 30 exposes only the name of the function 70 to the user 20 such that derived data 40 in a very simple format may be passed to the client computer 100. When new functions 70-1 to 70-N may be added, the software 160 on the client computer 100 need not be impacted (unlike an Applet, which must be updated if new functionality is created). To perform a function 70, the spreadsheet application 180 need only know the name 80 of the function 70 and any necessary attributes or arguments 85-1 to 85-N.

A request 1000 may be formatted in a spreadsheet of the spreadsheet application 180 as follows [“BANKNAME” (“FUNCTIONNAME,” “ATTRIBUTE_{—}1,” “ATTRIBUTE_{—}2” . . . “ATTRIBUTE_N”)]. Certain example functions 70-1 to 70-N, names 80-1 to 80-N and attributes 85-1 to 85-N may include: (1) a request 1000-1 for time series data from a database 520 [BANKNAME(DBQUERY, start_date, end_date, ticker_array, calendar, frequency)]; (2) a request 1000-2 for historical index constituents and weights [BANKNAME (GetlndexConstituents, date, index_ticker)]; (3) a request 1000-3 to calculate an average correlation of a basket over time [BANKNAME (BasketAvgCorrel, start_date, end_date, ticker_array, weight_array, calendar, frequency)]; (4) a request 1000-4 to calculate an average correlation of an index over time [BANKNAME(IndexAvgCorrel, start_date, end_date, index_ticker, calendar, frequency)]; (5) a request 1000-5 to get live data from a market distribution service 515 such as TIB [BANKNAME(TIB, ric_array)]; (6) a request 1000-6 to get a handle to an index from a handle server 510 [BANKNAME(GetlndexHandleFromTicker, index_ticker)]; (7) a request 1000-7 to map an International Securities Identification Number (ISIN) to a routing identifier code (RIC) [BANKNAME(XrefTicker, isin_array, ISIN, RIC)]; and other functions 70-1 to 70-N.

In one embodiment, the access server 300 may store and “remember” baskets previously built. For example, using a “CreateBasket” function, a user 20 may establish the contents of a particular basket to include, e.g., a number of specific stocks [BANKNAME(CreateBasket, “ticker 1”, “ticker 2”)].

II. Method Embodiments of the Invention

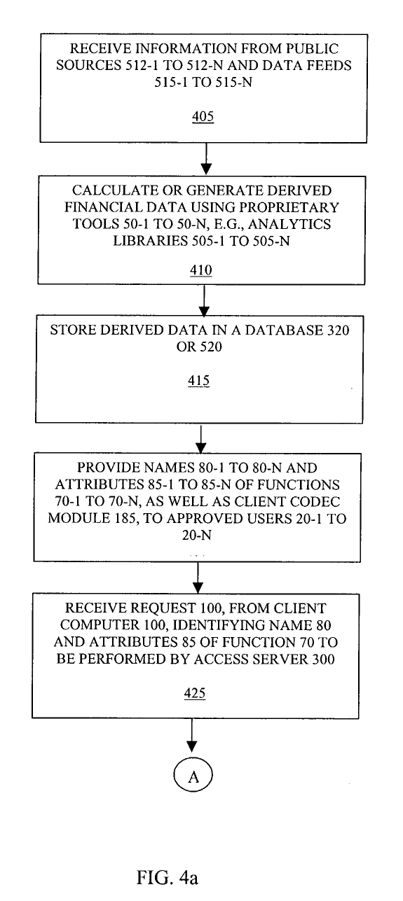

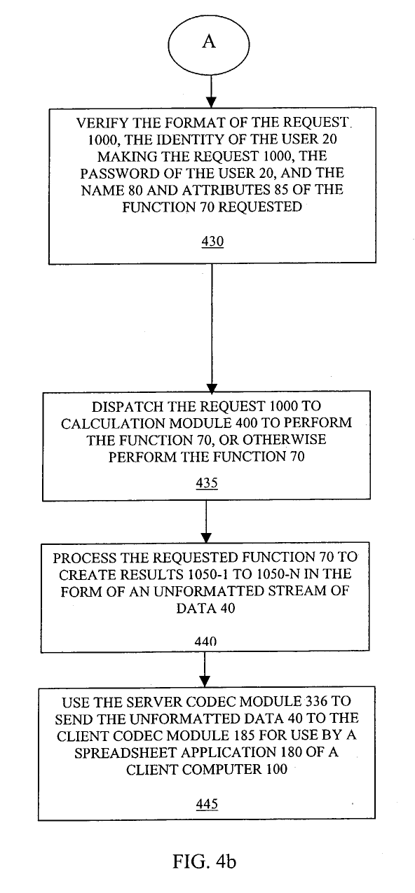

Having described the structure and functional implementation of certain aspects of embodiments of the present invention, the operation and use of certain embodiments will now be described with reference to FIGS. 4a-4b, and continuing reference to FIGS. 1-3.

Rather than a number of users 20-1 to 20-N each having access to proprietary tools 50-1 to 50-N (e.g., market analysis tools), one method embodiment of the present invention allows a user 20 to access data 40 derived from those tools 50-1 to 50-N, but not to access directly or copy the tools 50-1 to 50-N. For example, a user 20 may be provided data 40 based upon calculations that access the proprietary analytics libraries 515-1 to 515-N of a financial institution 30. However, the user 20 is not provided direct access to those proprietary analytics libraries 505-1 to 505-N themselves. The data sought by the user 20 may be, e.g., data derived from other data, or a manipulation of other data. For example, derived data 40 sought by a user 20 may include the price of an equity derivative. This price is one example of data derived from other data—namely a future price derived from a current price. In such an example, there may be no standard way to establish the price for the derivative.

As another example, derived data 40 sought by a user 20 may include a foreign currency exchange rate. The financial institution 30 may generate a single exchange rate for a particular currency based upon manipulation of a number of exchange rates such as the rates posted on different exchanges. In this example, there may be no standard way to establish such an exchange rate. Thus, using a common platform that a user 20 is familiar with, e.g., a commercially available spreadsheet application 180, the user 20 may use the analytics libraries 505-1 to 505-N of a financial institution 30 without gaining direct access to such analytics libraries 505-1 to 505-N, and without the need to get a copy of the analytics libraries 505-1 to 505-N.

FIGS. 4a and 4b illustrate certain operations performed in one embodiment of a method of providing selected users 20-1 to 20-N of a financial institution 30 with access to derived data 40. In one embodiment, the financial institution 30 may receive information from public sources 512-1 to 512-N, and from feeds 515-1 to 515-N provided for a fee by other companies (e.g., Bloomberg, Routers, Thompson First Call, etc.) (step 405). The financial institution 30 may then calculate derived data 40 using proprietary tools 50-1 to 50-N, such as may be found in analytics libraries 505-1 to 505-N (step 410). In one method embodiment, the financial institution 30 may store the derived data 40 in a database 320 or 520 (step 415). The financial institution 30 may provide authorized users 20-1 to 20-N with the names 80-1 to 80-N and attributes 85-1 to 85-N of predefined functions 70-1 to 70-N offered by the financial institution (step 420). A customer or user 20 may then send the access server 300 of the financial institution 30 a request 1000 identifying a predefined function 70 by its name 80, and including any necessary attributes 85-1 to 85-N (step 425). At such time, the access server 300 may verify the format of the request 1000, the identity of the user 20 making the request 1000, the password of the user 20, and the name 80 and attributes 85-1 to 85-N of the function 70 requested (step 430). If all of these are appropriate, the access server 300 may perform the requested function 70. In particular, the access server 300 may then dispatch the request 1000 to one or more calculation modules 400-1 to 400-N (step 435), or otherwise perform the function 70 itself if appropriate. Such function 70 may include, e.g., a look-up function 75, a calculation function 78, or a combination of the two. The calculation module(s) 400-1 to 400-N may then process the requested function 70 and create results 1050-1 to 1050-N in the form of a stream of unformatted data 40 (step 440). The access server 300, via the server codec module 336, then may send the stream of unformatted data 40 to the client codec module 185 on the client computer 100 for use by the customer or user 20 (step 445).

The client codec module 185 may allow the unformatted stream of data 40 to be sent to the client computer 100 for direct entry into the spreadsheet application 180. Then, using the client computer 100, a user 20 may directly manipulate the unformatted stream of data 40 from the access server 300 using the spreadsheet application 180 environment.

Although illustrative embodiments and example methods have been shown and described herein in detail, it should be noted and will be appreciated by those skilled in the art that there may be numerous variations and other embodiments which may be equivalent to those explicitly shown and described. For example, the scope of the present invention is not necessarily limited in all cases to execution of the aforementioned steps in the order discussed. Unless otherwise specifically stated, the terms and expressions have been used herein as terms and expressions of description, not of limitation. Accordingly, the invention is not limited by the specific illustrated and described embodiments and examples (or the terms or expressions used to describe them) but only by the scope of appended claims.

We claim:

1. A system for use in providing selected customers of a financial institution with access to secure data, said system comprising:
a computer-implemented market analysis tool adapted to compute, based on a market condition, a financial data derived from a publicly available data source for a financial instrument, wherein said market analysis tool is proprietary and accessible only by authorized personnel within said financial institution; and
a first computing device configured to:
receive, from at least one of said selected customers, a request for said financial institution to perform a predefined function, wherein said selected customer comprises a user other than said authorized personnel, wherein said predefined function uses said derived financial data to create a result, and wherein said request is generated at least in part by including an identifier corresponding to said predefined function in a spreadsheet program running or otherwise accessible on a second computing device; and
provide said result of said predefined function to said second computing device.

2. The system of claim 1, further comprising an interface adapted to interpret said result for use by at least one of said selected customers.

3. The system of claim 2, wherein said interface comprises a software program provided by said financial institution for execution on said second computing device.

4. The system of claim 2, wherein said result comprises a stream of unformatted data to be interpreted by said interface.

5. The system of claim 1, wherein said predefined function comprises accessing a database controlled by said financial institution, said database comprising said derived financial data.

6. The system of claim 1, wherein said predefined function comprises an instruction causing said computer-implemented market analysis tool to compute said derived financial data.

7. The system of claim 1, wherein said second computing device is in communication with said first computing device via a public network.

8. The system of claim 7, wherein said public network comprises an internet.

9. The system of claim 1, wherein said financial instrument comprises an equity derivative.

10. The system of claim 1, wherein said market condition comprises information obtained by said financial institution from a third party.

11. The system of claim 1, wherein said computer-implemented market analysis tool comprises an analytics model used by said financial institution to evaluate a risk factor associated with a financial instrument.

12. The system of claim 1, wherein said first computing device comprises a server device controlled by said financial institution and said second computing device comprises a client device controlled by at least one of said selected customers.

13. The system of claim 1, wherein said market analysis tool comprising a pricing tool, and said derived financial data comprises a price for a financial instrument.

14. A computer-implemented method for providing selected customers of a financial institution with access to secure data, the method comprising:
computing financial data derived from a publicly available data source using a computer-implemented market analysis tool that is proprietary and accessible only by authorized personnel within said financial institution;
receiving, from at least one of said selected customers, a request for said financial institution to perform a predefined function, wherein said selected customer comprises a user other than said authorized personnel, wherein said predefined function uses said derived financial data to create a result, and wherein said request is generated at least in part by including an identifier corresponding to said predefined function in a spreadsheet program running or otherwise accessible on a remote computing device accessible by said selected customer;
performing said predefined function; and
providing said result of said predefined function to said remote computing device.

15. The method of claim 14, further comprising formatting said result for use by at least one of said selected customers, said formatting comprising coding said result for decoding by an interface comprising a software program for execution on said remote computing device, said software program provided by said financial institution.

16. The method of claim 14, wherein said result comprises a stream of unformatted data for use in said spreadsheet program.

17. The method of claim 14, wherein said performing said predefined function comprises accessing a database controlled by said financial institution, said database comprising said derived financial data.

18. The method of claim 14, wherein said performing said predefined function comprises causing said computer-implemented market analysis tool to compute said derived financial data.

19. The method of claim 14, wherein said financial instrument comprises an equity derivative.

20. The method of claim 14, further comprising obtaining said market condition from a third party.

21. The method of claim 14, wherein said computer-implemented market analysis tool comprises an analytics model used by said financial institution to evaluate a risk factor associated with a financial instrument.

22. The method of claim 14, wherein said market analysis tool comprising a pricing tool, and said derived financial data comprises a price for a financial instrument.

23. A computer-implemented method, comprising:
calculating a price for a derivative financial instrument, said calculating comprising accessing a proprietary information source to produce a result;
receiving a request from a client computer, wherein said request comprises a calling statement corresponding to an approved operation, and said client computer comprises a codec module and a spreadsheet application; and
transmitting to said client computer an unformatted data stream comprising said result.

24. The method of claim 23, further comprising using said codec module to prepare said result for use in said spreadsheet application.

25. The method of claim 23, wherein said proprietary information source comprises a collection of data generated by a proprietary tool.
